(19) United States
(12) Patent Application Publication
(10) Pub. No.: US 2026/0148044 A1
(43) Pub. Date: May 28, 2026

(54) PERFORMANCE–BASED CONTENT GENERATION AND EXPLORATION USING MULTIMODAL GENERATIVE MODEL

(71) Applicant: Adobe Inc., San Jose, CA (US)

(72) Inventors: Zhenyu YAN, Cupertino, CA (US); Saayan MITRA, San Jose, CA (US); Ritwik SINHA, Cupertino, CA (US); Eunyee KOH, Sunnyvale, CA (US); Baldo FAIETA, San Francisco, CA (US); Viswanathan SWAMINATHAN, Saratoga, CA (US)

(21) Appl. No.: 18/957,511

(22) Filed: Nov. 22, 2024

(51) Int. Cl. G06N 3/0475; G06N 3/0455

(52) U.S. Cl. CPC G06N 3/0475; G06N 3/0455

(57) ABSTRACT

Some aspects relate to technologies for performance-guided content generation and exploration using a multimodal generative model with a joint latent space learned from digital content items and their corresponding performance metrics. In accordance with some aspects, input is received for content generation. The input includes a digital content item and is encoded by one or more encoders of the multimodal generative model into a latent representation in the joint latent space. A latent space transformation from the latent representation of the input is performed to provide a transformed latent representation, which is decoded by one or more decoders of the multimodal generative model to generate an output digital content item. In some aspects, the one or more decoders also decode the transformed latent representation to generate a predicted performance metric for the output digital content item.

### CROSS-REFERENCE TO RELATED APPLICATIONS

This patent application is related by subject matter to the invention disclosed in the commonly assigned application U.S. Application No. (not yet assigned) (Attorney Docket Number P13427-US-1/427498), filed on even date herewith, entitled “MULTIMODAL GENERATIVE MODEL WITH JOINT LATENT SPACE FOR DIGITAL CONTENT ITEMS AND PERFORMANCE METRICS.” The aforementioned application is hereby incorporated by reference in its entirety.

### BACKGROUND

In the context of digital marketing, a content delivery system refers to a platform or set of tools designed to distribute digital marketing content over the Internet to target user devices effectively. This digital content can include, for instance, emails, social media posts, in-app messages, and any other digital marketing content. Goals of content delivery systems include ensuring that the right digital content reaches the right audience at the right time and in the right format, and through the most appropriate channels.

### SUMMARY

Some aspects of the present technology relate to, among other things, a content generation system for performance-based content generation and exploration using a multimodal generative model. The multimodal generative model integrates various modalities, including digital content items and performance metrics, into a unified framework. The multimodal generative model employs an encoder-decoder architecture with a joint latent space that captures the relationships between the different modalities, including digital content items and performance metrics (and in some aspects, additional data such as contextual data). The encoders of the multimodal generative model transform input data into latent representations, which can be merged into a combined latent representation in the joint latent space. The decoders of the multimodal generative model transform latent representations to generate output, including new digital content items and predicted performance metrics.

Training the multimodal generative model involves using a training dataset comprising training samples that can include digital content items paired with corresponding performance metrics (and in some aspects, additional data such as contextual data). The training process involves encoding the digital content item and performance metric(s) from each training sample into latent representations, merging the latent representations, and decoding the combined latent representation for each training sample into an output digital content item and predicted performance metric(s). Reconstruction losses are determined based on the output digital content item and predicted performance metric(s) for each training sample (i.e., relative to the digital content item and performance metric(s) in the training sample), and parameters of the multimodal generative model are updated (e.g., via backpropagation) based on the reconstructions losses. Other types of loss functions, such as cross-modal loss, can also be employed to train the multimodal generative model.

Once trained, the multimodal generative model can perform various inference tasks. Generally, each inference task involves accessing an input that can include one or more of the modalities on which the model has been trained (e.g., digital content items and/or target performance metric(s)), obtaining a latent representation in the joint latent space of the multimodal generative model based on the input, and decoding the latent representation to one or more outputs in modalities on which the model has been trained (e.g., output digital content items and/or predicted performance metrics). In some aspects, the process involves performing a latent space transformation on the latent space representation of the input to provide a transformed latent representation, and decoding the transformed latent representation to provide an output, including an output digital content item. The latent space transformation can be constrained or guided based on one or more of the inputs to maintain features of the constraining input(s). These capabilities enable the generation and exploration of different content variations while being guided by performance metrics.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating an example multimodal generative model in accordance with some implementations of the present disclosure;

FIG. 3 is a block diagram illustrating another example multimodal generative model in accordance with some implementations of the present disclosure;

FIG. 4 is a flow diagram showing a method for training a multimodal generative model in accordance with some implementations of the present disclosure;

FIG. 5 is a flow diagram showing a method for generating an output digital content item and a predicted performance metric for the output digital content using a multimodal generative model given an input digital content item in accordance with some implementations of the present disclosure;

FIG. 6 is a flow diagram showing a method for generating an output digital content item with using a multimodal generative model given an input digital content item and target performance metric in accordance with some implementations of the present disclosure;

FIG. 7 is a flow diagram showing a method for generated a predicted performance metric for a digital content item using a multimodal generative model in accordance with some implementations of the present disclosure;

FIG. 8 is a flow diagram showing a method for generating an output digital content item and a predicted performance metric for the output digital content using a multimodal generative model given an input prompt in accordance with some implementations of the present disclosure;

FIG. 9 is a flow diagram showing a method for generating an output digital content item using a multimodal generative model given a prompt and a target performance metric in accordance with some implementations of the present disclosure; and

FIG. 10 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “digital content item” refers to digital media that can be communicated over a network, such as the Internet, to user devices. A digital content item can include one or more modalities, such as text, image, audio, and video. In some aspects, the digital content item comprises marketing content (also referred to herein as a marketing message), intended to promote a product or service or to otherwise cause a potential customer to perform some action. A digital content item can be one of a number of different content types. By way of example only and not limitation, a digital content item can be an email, a banner advertisement, a social media post, a blog post, or a landing page. In some cases, a digital content item can be a portion of a marketing message, such as an image from a message having both an image and text or an object from within an image (i.e., an image portion).

The term “performance metric” is used herein to refer to a measurable value that assesses the effectiveness of digital content items in achieving specific goals, such as, for instance, driving online traffic, generating leads, or increasing sales. By of example only and not limitation, performance metrics can include: key performance metrics (KPIs), number of impressions, number of conversions, click-through-rate, conversion rate, cost per click, cost per conversion, return on spend/investment, bounce rate, engagement rate.

The term “contextual data” is used herein to refer to information or metadata about a recipient or target recipient of a digital content item, such as a recipient's environment, behaviors, or circumstances. Contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or engagement with specific digital content items; location; time of data of user interaction with a digital content item; previous user interactions with digital content items; and search queries submitted by the user. For instance, if a digital content item is provided to a recipient who entered a search query for “running shoes” on their mobile phone while located in a specific city, the contextual data includes the search term (“running shoes”), the device type (mobile), the location (city), and possibly even the time of day.

As used herein, the term “prompt” refers to textual input to a generative model to generate an output, including a digital content item. In some aspects, a prompt can comprise natural language text that guides or otherwise instructs the generative model in generating the output.

A “generative model” is a type of machine learning model that learns to generate output digital content from a given training dataset. Unlike discriminative models, which focus on predicting a label or class for input data, generative models aim to understand the underlying distribution of the data in order to generate output digital content. Generative models can generate output digital content by sampling from this learned distribution, in order to perform tasks like image generation and text synthesis. Examples of generative models include Variational Autoencoders (VAEs) and Generative Adversarial Networks (GANs).

The term “multimodal generative model” is used herein to refer to generative model that operates on inputs and/or generates outputs of different modalities, such as text, image, audio, and video. In accordance with aspects of the technology described herein, a multimodal generation model comprises one or more neural networks (i.e., artificial neural networks) that provide an encoder-decoder architecture with a joint latent space for different modalities. By way of example only and not limitation, a multimodal generative model can employ one or more of the following: a variational autoencoder (VAE), a generative adversarial network (GAN), a transformer, a cross-modal attention network, and a latent diffusion model.

The term “encoder” is used herein to refer to a neural network that compresses input data (such as an image or text) into a lower-dimensional representation, referred to herein as a “latent representation”. This compressed form captures essential features of the input, helping to reduce complexity. In accordance with aspects of the technology described herein, the encoders of a multimodal generative model can include a “content encoder,” a “performance metric encoder,” a “contextual data encoder,” and a “prompt encoder,” as well as other types of encoders.

A “content encoder” is an encoder that generates a latent representation of a digital content item. Different content encoder can be provided for different content modalities, such as a text encoder, an image encoder, an audio encoder, and a video encoder. When a digital content item comprises multiple content modalities, a different content encoder for each content modality can be employed to generate a latent representation of each modality.

A “performance metric encoder” is an encoder that generates a latent representation of a performance metric. One or more different performance metric encoders can be employed depending on the format of each performance metric.

A “contextual data encoder” is an encoder that generates a latent representation of contextual data. One or more different contextual data encoders can be employed depending on the format of each type of contextual data.

A “prompt encoder” is an encoder that generates a latent representation of a prompt. Because a prompt comprises text, the prompt encoder can be a type of text encoder.

The term “joint latent space” refers to a shared, abstract space of a multimodal generative model where latent representations from different modalities (e.g., text, images, audio, video, etc.) are mapped and aligned. Encoders for each modality generate these latent representations, which can be merged into “combined latent representations” in the joint latent space, allowing the multimodal generative model to capture cross-modal relationships and generate coherent outputs across different types of data. The joint latent space facilitates understanding and interaction between the modalities by representing their common features in a unified form.

A “merging component” refers to a portion of a multimodal generative model that merges multiple latent representations of input data into a combined latent representation in the joint latent space. The merging component can employ any of a variety of merging techniques, such as, for instance, concatenation, summation, averaging, attention mechanisms, cross-modal transformers, and bilinear pooling.

As used herein, a “latent space transformation” refers to a process of modifying a latent representation by applying a perturbation or other adjustment to it to provide a “transformed latent representation” in the joint latent space of a multimodal generative model. Latent space transformations are used herein to explore the joint latent space and generate variations of digital content items. By perturbing or otherwise adjusting latent representation, the multimodal generative model can create new digital content items with modified properties while preserving some input properties captured by the joint latent space.

The term “decoder” is used herein to refer to a neural network that takes data from the joint latent space of the multimodal generative model and transforms it into a higher-dimensional space, reconstructing an original input or generating new data. In accordance with aspects of the technology described herein, the decoders of a multimodal generative model can include a “content decoder,” a “performance metric decoder,” and a “contextual data decoder,” as well as other types of decoders.

A “content decoder” is a decoder takes a latent representation as input and generates a digital content item. Different content decoders can be provided for different content modalities, such as a text decoder, an image decoder, an audio decoder, and a video decoder. When a digital content item is being generated that comprises multiple content modalities, a different content decoder for each content modality can be employed to generate digital content in each modality, which are combined to provide the output digital content item.

A “performance metric decoder” is a decoder takes a latent representation as input and generates a performance metric. One or more different performance metric decoders can be employed depending on the format of each performance metric.”

A “contextual data decoder” is a decoder takes a latent representation as input and generates contextual data. One or more different contextual data decoders can be employed depending on the format of each type of contextual data.

As used herein, a “constraining input” refers to an input modality to a multimodal generative model that constrains or guides a latent space transformation to maintain features of that input modality. For instance, when an input includes a target performance metric and an input digital content item, the target performance metric can be a constraining input that is used to constrain a latent space transformation of a combined latent representation of the input in order to maintain features of the target performance metric. This provides a transformed latent space representation that is decoded to an output digital content item with predicted a performance metric that is the same as or similar to the target performance metric.

### Overview

Given the vast number of user devices and the incredible amount of content distributed on the Internet, the generation and delivery of digital content items to user devices poses a technical challenge for content delivery systems. For instance, in the current digital marketing era, enterprises face the challenge of creating digital content items in the form of email ads, display ads, and paid social media ads, in addition to maintaining other forms of online presence, such as blogs and social media accounts, among many others. The need for a plethora of new, unique, and appealing digital content items that not only engage recipients but also reflect the personality of the enterprise in the form of voice and tone, as well as their overall messaging attributes not limited to writing style, but also its brand definition, presents a significant challenge. Traditionally, many hours of careful human effort are required to create high quality content items that would pass the bar for publishing, as it is tied to the business and revenue for the company, among many other key performance indicators (KPIs).

More recently, enterprises have begun using generative models to assist in the content creation process. For instance, pre-trained generative models from Adobe, OpenAI, Google, Anthropic, and others, are becoming the modern workhorse of marketing content creation, with marketers and creatives constructing prompts for generating digital content with specific requirements. While at a high-level, these pre-trained generative models can be used for marketing content generation, their use presents some limitations. The pre-trained models are trained on large scale historic data on the Internet, which enables them to have a generic knowledge of marketing content, but they often do not have enough context about specific enterprises or its goals, often resulting in the generated content being mechanical and generic. The general nature of such pre-trained generative models results in the generation of digital content items in a relatively unstructured way with no way to know how the generated content will perform. Moreover, given the ability of such models to generate a large number of variants, it's difficult to determine which variants to use in campaigns.

While it is possible to include very specific instructions through in-context examples in prompts given to pre-trained generative models, it typically requires multiple passes through carefully constructed prompts to generate something that subjectively satisfies the user entering the prompt. Studies have shown that in-context learning can be unstable and very sensitive to the demonstrations included in the prompt. Also, this creates the overhead for creators to pick up the skill of prompt engineering and understand its nuances and limitations. The process is also time consuming due to the multiple back and forth in iterative prompting, which is interventional in nature.

Moreover, the amount of back and forth required between the prompter and the generative model to arrive at acceptable digital content items with the remaining uncertainty of how the digital content items will perform often results in the consumption of an unnecessary quantity of computing resources (e.g., I/O costs, network bandwidth usage, throughput, memory consumption, CPU/GPU usage, etc.). For instance, a user may submit an initial prompt, causing the generative model to generate content, which is presented to the user. The user reviews the generated content and issues another prompt to refine the content, causing the generative model to generate new content. The back and forth process of issuing a prompt and generating content by the generative model continues until the user decides the generated content is sufficient or otherwise decides to manually edit the content. Given the unstructured nature of this process, the number of times this back and forth occurs can be extensive.

Each iteration of this conventional process involves consumption of computer resources (e.g., bandwidth, memory, CPU/GPU usage), as well as puts wear and tear on physical computer components. For instance, repetitive prompts adversely affect computer network communications, increasing network bandwidth usage and latency. Additionally, the repetitive inputs from the user and content generation by the generative model increase memory usage, CPU/GPU usage, and storage device I/O (e.g., excess physical read/write head movements on non-volatile disk) because each time a user inputs another prompt, the computing system often has to reach out to the storage device to perform a read or write operation (which is time consuming, error prone, and can eventually wear on components, such as a read/write head) and/or consume processor and memory resources in executing the generative model to generate the content.

Aspects of the technology described herein improve the functioning of the computer itself in light of these shortcomings in existing technologies by providing a content generation system for performance-based content generation and exploration using a multimodal generative model. The content generation system is designed to enhance the creation and delivery of digital content items by leveraging advanced machine learning techniques to employ performance metrics to guide the content generation and exploration.

The multimodal generative model is designed to integrate a variety of data types, known as modalities, into a cohesive and unified framework. These modalities include digital content items, with content such as text, images, audio, and video, as well as performance metrics that measure the effectiveness of these digital content items. The model employs an advanced encoder-decoder architecture, which features a joint latent space. This joint latent space is a shared, abstract space where the relationships between different modalities are captured and represented.

The encoders of the multimodal generative model are specialized neural networks that process and transform input data from each modality into latent representations. These latent representations are lower-dimensional, compressed forms of the input data that retain essential features and characteristics. For instance, a text encoder might use a transformer-based architecture to convert textual content into a latent representation, while an image encoder might use a convolutional neural network (CNN) to process visual data.

Once the input data is encoded into latent representations, these representations can be merged into a combined latent representation within the joint latent space of the multimodal generative model. This merging process can involve various techniques, such as concatenation, summation, averaging, or more sophisticated methods like attention mechanisms and cross-modal transformers. The combined latent representation effectively captures the shared and unique features of the different modalities, allowing the model to understand and leverage the relationships between them.

The decoders of the multimodal generative model are responsible for transforming latent representations in the joint latent space back into higher-dimensional output data. Each decoder is tailored to generate specific types of output corresponding to the input modalities. For example, a text decoder might generate coherent and contextually relevant text, while an image decoder might produce high-quality images. The decoders can generate new digital content items, such as creating a new marketing message or social media post, and can also predict performance metrics, providing insights into how the generated content is likely to perform.

In some configurations, the multimodal generative model can also incorporate additional data, such as contextual information about a target audience or environment. This contextual data can further refine the latent representations and improve the relevance and effectiveness of the generated content. By integrating various data types and leveraging sophisticated neural network architectures, the multimodal generative model offers a powerful tool for creating and optimizing digital content across multiple modalities.

Training the multimodal generative model is a comprehensive process that utilizes a training dataset composed of numerous training samples. Each training sample can include digital content items paired with their corresponding performance metrics (e.g., obtained using various tracking mechanisms when the digital content items have been provided to recipients). In some configurations, additional data such as contextual information about a target audience or environment may also be included to enhance the model's understanding and performance.

The training process begins with encoding, in which the digital content items and performance metrics from each training sample are transformed into latent representations. Once the input data from a training sample is encoded into latent representations, these latent representations are merged into a combined latent representation within the joint latent space of the multimodal generative model. Following the merging process, the combined latent representation is decoded to generate an output, including a new digital content item and predicted performance metric(s). The decoders in the multimodal generative model are responsible for this transformation, converting the joint latent representation back into higher-dimensional output data.

To evaluate the accuracy of the generated outputs, reconstruction losses are calculated. These losses are determined by comparing the output digital content item and predicted performance metric(s) with the original digital content item and performance metric(s) from the training sample. The parameters of the multimodal generative model are then updated based on these reconstruction losses. This update process can involve backpropagation, an optimization algorithm that adjusts the model parameters to minimize the loss, thereby improving the multimodal generative model's performance. The training process can be iterative, continuously refining model parameters through multiple epochs until a stopping criterion is met (e.g., a predefined number of epochs, stabilization of the validation loss, or achievement of a performance improvement threshold).

In addition to reconstruction losses, other types of loss functions can be employed to train the multimodal generative model. For instance, cross-modal loss functions can be used to ensure that the model effectively captures the relationships between different modalities. Other loss functions that could be used depending on the model architecture can include adversarial loss, Kullback-Leibler (KL) divergence loss, and perceptual loss. These loss functions help the multimodal generative model learn to generate coherent and contextually relevant outputs across various data types, enhancing its overall performance and utility.

Once the multimodal generative model is trained, it can undertake a variety of inference tasks, leveraging its ability to process and generate data across multiple modalities. These tasks generally begin by accessing an input, which can include one or more of the modalities on which the model has been trained, such as digital content items (e.g., text, images, audio, video) and/or target performance metrics. The multimodal generative model then encodes the input data into one or more latent representations using its encoders, and in the case of multiple input modalities, merges the latent representations into a combined latent representation.

In some cases, a latent space transformation is performed on the latent representation of the input within the joint latent space to provide a transformed latent representation. This transformation can be a perturbation or other adjustment that explores the latent space to generate variations of the input data. The transformation can be constrained or guided by additional inputs, such as target performance metrics or contextual data, to ensure that the generated output maintains certain desired features. The latent representation of the input or transformed latent representation is decoded back into higher-dimensional output data using the multimodal generative model's decoders.

Content Exploration and Variation: One of the powerful capabilities of the multimodal generative model is its ability to generate and explore different digital content variations while taking into account performance metrics. By applying multiple latent space transformations, the multimodal generative model can produce a range of digital content variations from a single input digital content item. This is particularly useful for content generation tasks where multiple versions of a digital content item are needed, each optimized for different performance metrics or contextual settings.

Performance Prediction: The multimodal generative model can also predict performance metrics for generated digital content items. By decoding a latent representation into both a digital content item and one or more performance metrics, the multimodal model provides insights into how the generated digital content item is predicted to perform. This allows users to evaluate and select the most effective content variations based on predicted performance outcomes. In other use cases, a user can provide an input digital content item to obtain predicted performance metrics for that digital content item (with or without generating variants).

Contextual Adaptation: The multimodal generative model can adapt its outputs based on contextual data provided as input. For instance, if the input includes demographic information about the target audience, the multimodal generative model can generate a digital content item that is tailored to resonate with that specific audience. This contextual adaptation ensures that the generated digital content item is not only relevant but also optimized for the intended recipients.

Prompt-Based Generation: The multimodal generative can also support scenarios in which the multimodal generative model generates content based on a textual prompt where no initial digital content item is provided. The prompt is encoded into a latent representation, which is then decoded to produce a digital content item. The prompt-based content generation process can be constrained by aspects, such as target performance metrics and/or contextual data. This capability enables the generation of new digital content items from scratch, guided by natural language instructions in a prompt, and potentially constrained by other inputs.

Aspects of the technology described herein provide a number of improvements over existing technologies. For instance, the technology described herein employs a multimodal generative model that integrates various data types, such as digital content items and performance metrics, into a unified framework. This integration allows for a more comprehensive understanding and generation of digital content that is contextually relevant and optimized for performance. The use of an encoder-decoder architecture with a joint latent space enables the multimodal generative model to capture and leverage the relationships between different modalities (including digital content and performance metrics), resulting in more coherent and effective content generation. An advantage of this technology is its ability to generate multiple content variations efficiently. By applying latent space transformations, the multimodal generative model can explore a wide range of content variations from a single input, each optimized for different performance metrics and/or contextual settings. This capability not only enhances the flexibility and creativity of content generation but also ensures that the generated content is tailored to specific audience segments and performance goals. By incorporating performance metrics and/or contextual data into the content generation process, the multimodal generative model can predict how the generated content will perform, providing valuable insights that can guide content strategy and optimization. The ability to generate digital content items that are both relevant and effective reduces the need for extensive manual editing and iterative prompting, streamlining the content creation process. As a result, the multimodal generative model described herein offers improved computational efficiency. By leveraging advanced neural network architectures and optimization techniques, the technology described herein reduces the consumption of computer resources, such as bandwidth, memory, and CPU/GPU usage, compared to conventional content generation using pre-trained generative models. This efficiency not only lowers operational costs but also enhances the scalability and responsiveness of the content generation system. These improvements make the technology a powerful tool for creating high-quality, performance-optimized digital content in a resource-efficient manner.

### Example System for Multimodal Generative Model for Content Exploration

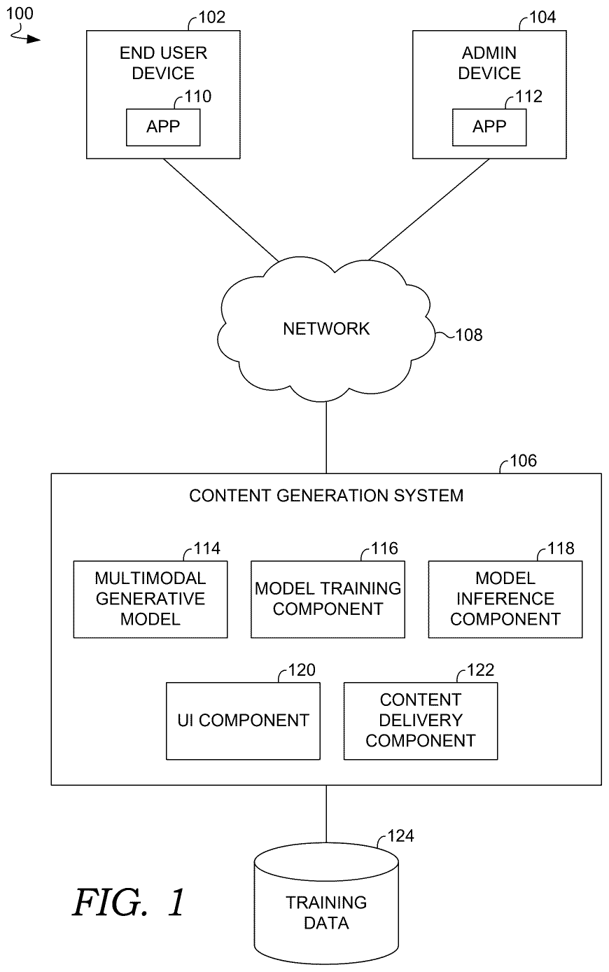

With reference now to the drawings, FIG. 1 is a block diagram illustrating an exemplary system 100 for performance-based content generation and exploration using a multimodal generative model with a joint latent space trained on digital content items and performance data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

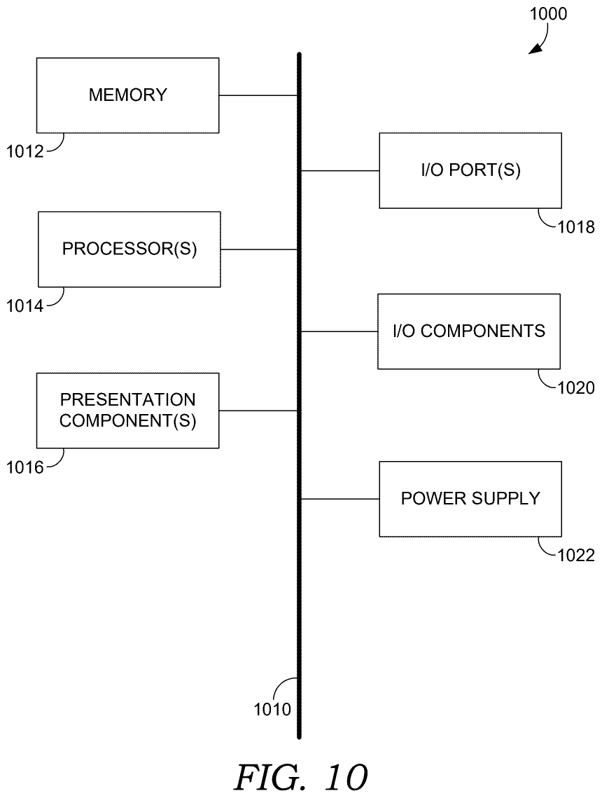

The system 100 is an example of a suitable architecture for implementing certain aspects of the present disclosure. Among other components not shown, the system 100 includes an end user device 102, an admin device 104, and a content generation system 106. Each of the end user device 102, the admin device 104, and the content generation system 106 shown in FIG. 1 can comprise one or more computer devices, such as the computing device 1000 of FIG. 10, discussed below. As shown in FIG. 1, the end user device 102, the admin device 104, and the content generation system 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content generation system 106 could be provided by multiple server devices collectively providing the functionality of the content generation system 106 as described herein. Additionally, other components not shown may also be included within the network environment.

The end user device 102 and the admin device 104 can each be a client device on the client-side of operating environment 100, while the content generation system 106 can be on the server-side of operating environment 100. The content generation system 106 can comprise server-side software designed to work in conjunction with client-side software on the end user device 102 and the admin device 104 so as to implement any combination of the features and functionalities discussed in the present disclosure. For instance, the end user device 102 can include an application 110 and the admin device 104 can have an application 112 for interacting with the content generation system 106. The application 110 and the application 112 can each be, for instance, a web browser or a dedicated application for providing functions, such as those described herein. This division of operating environment 100 is provided to illustrate one example of a suitable environment, and there is no requirement for each implementation that any combination of the end user device 102, the admin device 104, and/or the content generation system 106 remain as separate entities. While the operating environment 100 illustrates a configuration in a networked environment with a separate end user device, admin device, and content generation system, it should be understood that other configurations can be employed in which aspects of the various components are combined. For instance, in some aspects, aspects of the content generation system 106 can be implemented in part or in whole by the end user device 102 and/or the admin device 104.

The end user device 102 and the admin device 104 can each comprise any type of computing device capable of use by a user. For example, in one aspect, the end user device 102 and the admin device 104 may each be the type of computing device 1000 described in relation to FIG. 10 herein. By way of example and not limitation, the end user device 102 and the admin device 104 can each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the end user device 102 and can interact with the content generation system 106 via the end user device 102. As used herein, an end user is an individual who is a recipient of a digital content item from the content generation system 106. An administrative user can be associated with the admin device 104 and can interact with the content generation system 106 via the admin device 104. As used herein, an administrative user is an individual who interacts with the content generation system 106 to generate a digital content item for distribution to one or more end users.

The content generation system 106 leverages a multimodal generative model 114 to generate digital content items based on input received from administrative users via admin devices, such as the admin device 104. Once digital content items are completed, the content generation system 106 facilitates distribution of the digital content items over the network 108 to end user devices, such as the end user device 102, using the appropriate communication channels based on the type of digital content item.

As shown in FIG. 1, the content generation system 106 includes a multimodal generative model 114, a model training component 116, a model inference component 118, a user interface component 120, and a content delivery component 122. The components of the content generation system 106 may be in addition to other components that provide further additional functions beyond the features described herein. The content generation system 106 can be implemented using one or more server devices, one or more platforms with corresponding application programming interfaces, cloud infrastructure, and the like. While the content generation system 106 is shown separate from the end user device 102 and the admin device 104 in the configuration of FIG. 1, it should be understood that in other configurations, some or all of the functions of the content generation system 106 can be provided on the end user device 102 and/or the admin device 104. Additionally, in some configurations, one or more of the components of the content generation system 106 shown in FIG. 1 can be provided by the end user device 102, the admin device 104, and/or another location not shown in FIG. 1. The components can be provided by a single entity or multiple entities.

In some aspects, the functions performed by components of the content generation system 106 are associated with one or more applications, services, or routines. In particular, such applications, services, or routines may operate on one or more user devices, servers, may be distributed across one or more user devices and servers, or be implemented in the cloud. Moreover, in some aspects, these components of the content generation system 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The multimodal generative model 114 comprises one or more neural networks (i.e., artificial neural networks) that provide an encoder-decoder architecture with a joint latent space for different modalities, including digital content items and performance metrics. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output. By way of example only and not limitation, the multimodal generative model 114 can employ one or more of the following: a variational autoencoder (VAE), a generative adversarial network (GAN), a transformer, a cross-modal attention network, and a latent diffusion model.

The multimodal generative model 114 includes separate encoders that generate latent representations of different input modalities. Each encoder comprises a neural network architecture that extracts features representing the input modality in a compressed, meaningful way. By way of example only and not limitation, text encoders for text data could employ recurrent neural networks (RNNs) or transformer-based architectures. Image encoders for image data could employ, for instance, convolutional neural networks (CNNs) or vision transformers. Audio and/or video encoders for audio/video data could employ, for instance, combinations of RNNs and CNNs (including 3-dimensional CNNs) or transformer-based architectures.

In accordance with some aspects, the multimodal generative model 114 includes at least a content encoder and a performance metric encoder. The content encoder generates latent representations of digital content items. In some aspects, the content encoder can comprise multiple encoders for different content modalities, such as a text encoder, image encoder, audio encoder, and video encoder. The performance metric encoder generates latent representations of performance metrics. In some aspects, multiple performance metric encoders can be provided for different types of performance metrics.

In some configurations, the multimodal generative model 114 includes additional encoders, such as a contextual data encoder and a prompt encoder. The contextual data encoder generates latent representations of contextual data, while the prompt encoder generates latent representations of text from prompts (e.g., entered by an administrative user using an admin device, such as the admin device 104). Any number of additional encoders can be included in the architecture of the multimodal generative model 114 to handle additional types of input in accordance with various aspects of the technology described herein.

The joint latent space of the multimodal generative model 114 captures the underlying semantics of different modalities, allowing the multimodal generative model 114 to understand and relate the information across the modalities. In order to provide combined latent representations of different modalities in the joint latent space, the multimodal generative model 114 also includes a merging component that merges latent representations of different inputs (e.g., via concatenations, summation, average, and/or other fusion techniques). The combined latent representations in the joint latent space capture shared representations of different data types, allowing for interactions and transformations between modalities.

After encoding inputs into the joint latent space, the multimodal generative model 114 includes one or more decoders to generate outputs. Each decoder comprises a neural network architecture specialized to produce a specific type of output given a latent representation in the joint latent space. By way of example only and not limitation, text decoders to generate text data could employ RNNs or transformer-based architectures. Image decoders for generating image data could employ, for instance, convolutional neural networks (CNNs) or vision transformers. Audio and/or video decoders for generating audio/video data could employ, for instance, combinations of RNNs and CNNs (including 3-dimensional CNNs) or transformer-based architectures.

In some aspects, the multimodal generative model 114 includes a content decoder that generates digital content items for output. The content decoder can comprise multiple decoders for generating content in different content modalities, such as a text decoder, image decoder, audio decoder, and video decoder. The multimodal generative model 114 can also include a performance metric decoder that generates predicted performance metrics. In some further aspects, the multimodal model 112 includes a contextual data decoder that generates contextual data as output.

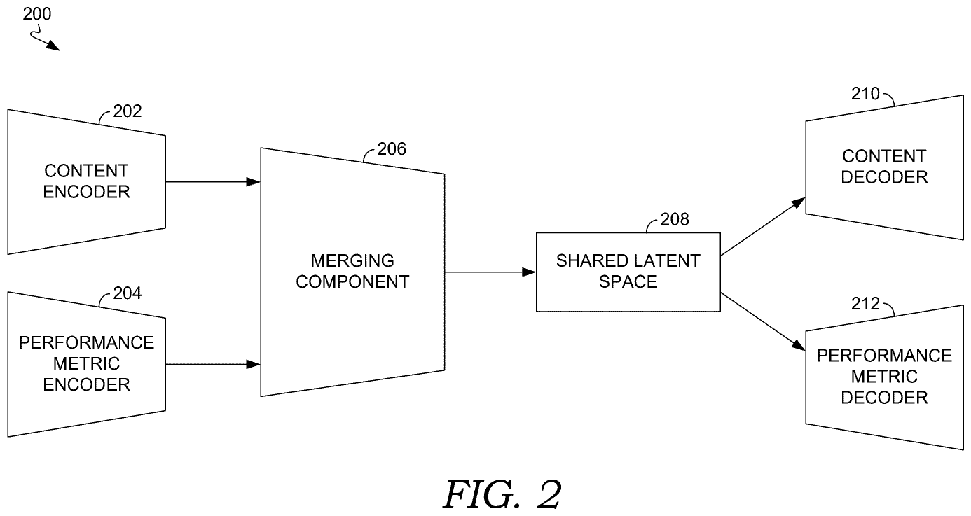

FIG. 2 provides a block diagram showing an example multimodal generative model 200 in accordance with some aspects of the technology described herein. As shown in FIG. 2, the multimodal generative model 200 includes a content encoder 202 and a performance metric encoder 204. Given a digital content item as input, the content encoder 202 generates a latent representation of the digital content item. The digital content item could be, for instance, an entire marketing message that could include a single modality or multiple content modalities, such as a message with an image overlaid with text. Alternatively, the digital content item could be only a portion of a marketing message. For instance, the digital content item could be just the image from a marketing message that includes both an image and text. As another example, the digital content item could be a portion of an image with an object, instead of the entire image.

Although only a single content encoder 202 is shown in FIG. 2, the multimodal generative model 200 could employ any number of content encoders, with the content encoders operating on different modalities. For instance, a digital content item could include any number of different modalities, such as text, image, audio, and video. Accordingly, the multimodal generative model 200 could include a content encoder for the various modalities, such as a text encoder, an image encoder, an audio encoder, and a video encoder. The type of content encoder(s) used for a given digital content item is based on the modality of the digital content item provided as input. For instance, when the digital content item is an image, an image encoder is employed to generate a latent representation, and when the digital content item is text, a text encoder is employed to generate a latent representation. In some instances, a digital content item includes multiple modalities, and a different content encoder is used to generate a latent representation for each modality. For example, in the case of a digital content item having both an image and text, an image encoder generates a latent representation of the image, and a text encoder generates a latent representation of the text.

Given a performance metric as input, the performance metric encoder 204 generates a latent representation of the performance metric. The performance metric could be any measurable value for assessing the effectiveness of digital content items in achieving specific goals. For instance, the performance metric could be: a key performance metric (KPIs), a number of impressions, a number of conversions, a click-through-rate, a conversion rate, a cost per click, a cost per conversion, a return on spend/investment, a bounce rate, or an engagement rate. In some instances, multiple performance metrics are received as input. In some aspects in which multiple performance metrics are provided as input, a single performance metric encoder 204 generates a latent representation for all the performance metrics. In other aspects in which multiple performance metrics are provided as input, multiple performance metric encoders could be employed. Each performance metric encoder could be configured to generate a latent representation for each different type of performance metric.

The merging component 206 merges latent representations produced by the content encoder 202 and the performance metric encoder 204 to provide a combined latent representation in a latent space 208 of the multimodal generative model 200. The merging component 206 can merge latent representations using any of a variety of merging techniques. For instance, one approach is concatenation, where the latent representations are combined into a larger vector. Summation and averaging (weighted or unweighted) are other approaches, where the latent representations are added element-wise (summation) or averaged (averaging), producing a more compact representation. Another method involves the use of attention mechanisms, which dynamically weigh the contributions of different latent representations before merging them. Cross-modal transformers can also be used by learning interactions between different modalities through multi-headed self-attention, capturing fine-grained relationships across modalities. Bilinear pooling takes a different approach by computing pairwise interactions between latent representations through an outer product.

The joint latent space 208 of the multimodal generative model 200 is trained to capture relationships and correlations between different modalities, including content and performance metrics, ensuring that semantically similar concepts from the different inputs are mapped to nearby points in the space. This allows the multimodal generative model 200 to effectively integrate and leverage information from both digital content items and performance metrics. The joint latent space 208 not only reflects the distinctive information from each modality but also preserves their interrelationships, enabling the multimodal generative model 208 to perform inference tasks that require deep multimodal understanding.

As shown in FIG. 2, the multimodal generative model 200 also includes a content decoder 210 and a performance metric decoder 212. Given a latent representation in the joint latent space 208, the content decoder 210 generates a digital content item. Although only a single content decoder 210 is shown in FIG. 2, the multimodal generative model 200 could employ any number of content decoders, with each content decoder generating content in a different modality. For instance, the content decoders could include an image decoder for generating images, a text decoder for generating text, an audio decoder for generating audio, and/or a video decoder for generating video. Each content decoder takes as input a latent representation from the joint latent space 208 in order to generate content in a specific modality. In some cases, a digital content item is generated that includes multiple modalities by using a content decoder for each modality to generate content in each modality and then combining the generated content to provide the digital content item. For instance, given a latent representation, an image decoder could generate an image from the latent representation, and a text decoder could generate text from the latent representation, and the image and text could be combined to provide the output digital content item.

Given a latent representation from the joint latent space 208, the performance metric decoder 212 generates a performance metric. The performance metric could be any measurable value for assessing the effectiveness of digital content items in achieving specific goals. For instance, the performance metric could be: a key performance metric (KPIs), a number of impressions, a number of conversions, a click-through-rate, a conversion rate, a cost per click, a cost per conversion, a return on spend/investment, a bounce rate, or an engagement rate. In some instances, multiple performance metrics can be generated by a single performance metric decoder or multiple performance metric decoders, where each performance metric decoder could be configured to generate a different type of performance metric.

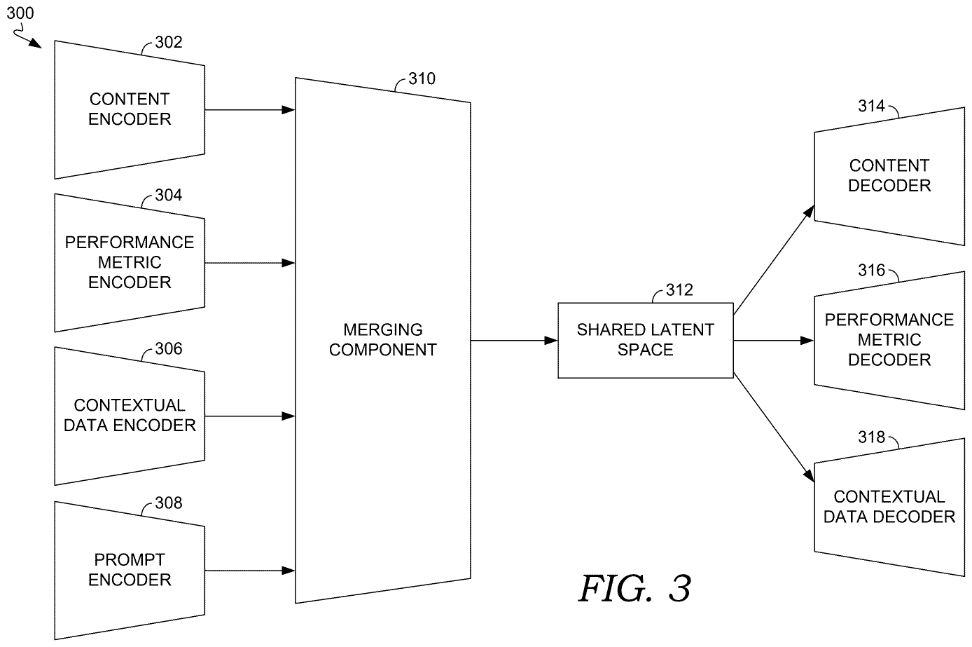

While FIG. 2 presents a configuration in which the multimodal generative model 200 includes encoders and decoders for content and performance metrics, in further aspects, a multimodal generative model can have additional encoders and/or decoders for other types of data. FIG. 3 provides an example of a multimodal generative model 300 with additional encoders and decoders to incorporate additional modalities. As shown in FIG. 3, the multimodal generative model 300 includes a content encoder 302, a performance metric encoder 304, a contextual data encoder 306, and a prompt encoder 308. While only a single content encoder 302, a single performance metric encoder 304, a single contextual data encoder 306, and a single prompt encoder 308 are shown in FIG. 3, it should be understood that any number of each different type of encoder could be employed. Additionally, other encoders not shown in FIG. 3 could be employed.

The content encoder 302 of the multimodal generative model 300 can be similar to the content encoder 202 discussed above with reference to FIG. 2. Similarly, the performance metric encoder 304 of the multimodal generative model 300 can be similar to the performance metric encoder 204 discussed above with reference to FIG. 2.

The contextual data encoder 306 takes contextual data as input and generates a latent representation of the contextual data. The contextual data comprises information or metadata about recipients or targets recipient of a digital content item, such as recipients' environment, behaviors, or circumstances. Contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or engagement with specific digital content items; location; time of data of user interaction with a digital content item; previous user interactions with digital content items; and search queries submitted by the user.

The contextual data encoder 306 enables contextual data to be taken into account in conjunction with digital content items and performance metrics. For instance, a combined latent representation could be generated given performance metrics for a given population of recipients (as specified by certain contextual data describing the recipients) for a given digital content item. In this way, for a given digital content item, different combined latent representations could be generated based on different performance metrics for different populations of recipients (i.e., different contextual data). This facilitates understanding the influence of contextual data in the performance of digital content items, and to take contextual data into account when generating digital content items.

The prompt encoder 308 takes a prompt comprising text as input and generates a latent representation of the prompt. In some aspects, the text can comprise natural language text entered by an administrative user to guide generation of digital content items. For instance, an administrative user could provide as input a digital content item that includes an image of a person wearing a shirt and a prompt with text specifying to change the color of the shirt to a different color.

Similar to the merging component 206 of FIG. 2, the merging component 310 of the multimodal generative model 300 merges latent representations produced by the various encoders in a joint latent space 312. The merging component 310 can merge latent representations using any of a variety of merging techniques (e.g., concatenation, summation, averaging, attention mechanisms, cross-modal transformers, bilinear pooling, etc.).

The content decoder 314 of the multimodal generative model 300 can be similar to the content decoder 210 discussed above with reference to FIG. 2. Similarly, the performance metric decoder 316 of the multimodal generative model 300 can be similar to the performance metric decoder 212 discussed above with reference to FIG. 2.

Given a latent representation from the joint latent space 312, the contextual data decoder 318 generates contextual data. As noted above, the contextual data can include information or metadata about recipients or target recipients of a digital content item, such as a recipient's environment, behaviors, or circumstances.

With reference again to FIG. 1, the model training component 116 of the content generation system 106 facilitates training the multimodal generative model 114 using training data from a data store 124. In accordance with some aspects, the training data comprises training samples, where each training sample comprises a digital content item paired with one or more performance metrics for the digital content item. Each digital content item in the training samples can comprise an entire marketing message (with one or more content modalities) or a portion of a marketing message (e.g., an image from a marketing message having both an image and text; or an object in an image) that has been delivered to recipients.

The performance metric(s) for a digital content item in a training sample provides information regarding the performance of the digital content item based on recipient actions performed in response to receiving the digital content item. For instance, the content generation system 106 or associated system can include a performance tracking component (not shown) that tracks the performance of digital content items provided to recipients, and the training data in the data store 124 could be generated using the tracked performance information. The performance tracking component could use any of a number of different mechanisms for tracking the performance of digital content items sent over networks (e.g., the Internet), such as emails, push notifications, or in-app messages. By way of example only and not limitation, the tracking mechanisms could include use of cookies, tracking pixels, URL tracking, browser fingerprinting, IP address tracking, device fingerprinting, impression tracking, conversion tracking, and ad tags.

In further aspects, the training data includes additional data, such as contextual data. In configurations using contextual data, a training sample can include a combination of a digital content item with performance metric(s) for certain contextual data. This allows for different performance metrics to be provided for a given digital content item with different sets of contextual data. For example, different training samples could include performance metrics for a given digital content item for different user demographic groups to reflect how the digital content item performed with each user demographic group.

As previously indicated, the multimodal generative model 114 comprises one or more neural networks. In some aspects, the model architecture of the multimodal generative model 114 is built and trained from scratch; while in other aspects, one or more pre-trained models are selected, configured, and fine-tuned. The multimodal generative model 114 can also be initialized by setting initial values for model parameters (e.g., weights), selecting loss function(s) for training, and setting hyperparameters for training the model, such as, for instance, regularization parameters, model parameters (e.g., a number of layers in a neural network), learning rate, batch sizes selected from the training data, and so on.

After initialization, the model training component 116 trains the multimodal generative model 114 using training samples from the training data to update parameters (e.g., weights) of the multimodal generative model 114 in order to learn a joint latent space that captures cross-modal relationships (including the relationship between digital content items and performance metrics) and enables the generation of coherent outputs, including new digital content items and predicted performance metrics. Generally, the training process includes iteratively performing a forward pass in which a training sample (or a batch of training samples) is provided as input to the multimodal generative model 114, determining one or more losses from model output(s), and updating model parameters (e.g., via backpropagation) based on the loss(es).

In some aspects, the multimodal generative model 114 is trained using reconstruction losses for digital content images and performance metrics (which can be a regression loss in the case of continuous values for the performance metrics). When a training sample includes other data (e.g., contextual data), a reconstruction loss for the additional data can also be used for training. A training iteration can include a forward pass in which a training sample comprising a digital content item and performance metric(s) is provided as input to the multimodal generative model 114, and the multimodal generative model 114 uses its encoders to generate latent representations of the digital content item and performance metric(s), merges the latent representations into a combined latent representation, and uses its decoders to generate an output digital content item and predicted performance metric(s) from the combined latent representation. A reconstruction loss for the digital content item modality is determined from the output digital content item and the digital content item from the training sample. A reconstruction loss (e.g., a regression loss in the case of continuous values) for the performance metric modality is also determined from the predicted performance metric(s) and the performance metric(s) from the training sample. When the training sample includes additional data (e.g., contextual data), a similar process is performed that involves the additional data.

In some aspects, the multimodal generative model 114 is also trained using cross-modal losses. This can include, for instance, accessing a training sample that includes a digital content item and one or more performance metrics. A forward pass is performed by providing the digital content item as input to the multimodal generative model 114 without the performance metric(s) to generate a latent representation that is decoded to one or more predicted performance metrics. A cross-modal loss is then determined using the predicted performance metric(s) and the performance metric(s) from the training sample. In some aspects, the training sample also includes other data (e.g., contextual data), which can be included in the forward pass with the digital content item.

The loss functions discussed above are provided by way of example only and not limitation. Additional or alternative loss functions can be used in accordance with various aspects of the technology described herein. For instance, any combination of the following loss functions could be employed: reconstruction loss, regression loss, cross-modal loss, adversarial loss (e.g., in the case of a GAN), Kullback-Leibler (KL) divergence loss (e.g., in the case of a VAE), and perceptual loss, to name a few.

Once the multimodal generative model 114 has been trained, the model inference component 118 enables use of the trained multimodal generative model 114 for content generation and exploration. For instance, an administrative user can provide input via an admin device, such as the admin device 112, and the inference component 118 provides the input to the multimodal generative model 114 to perform an inference task. Depending on the encoders and decoders included in the multimodal generative model 114, different inference tasks can be performed on different combinations of inputs. The following provides a description of various inference tasks that can be performed using different inputs. However, it should be understood that these are provided by way of example only and other combinations of inputs and inference tasks can be performed using the multimodal generative model 114

In some aspects, the inference component 118 facilitates content exploration in which a digital content item is provided as input to the multimodal generative model 114, and the multimodal generative model 114 outputs one or more variant digital content items. In some instances, a digital content item is the only input. In such instances, a content encoder provides a latent representation of the digital content item in the latent space of the multimodal generative model 114. A latent space transformation (e.g. a perturbation) is then applied to the latent representation of the digital content item in the joint latent space of the multimodal generative model 114 to provide a transformed latent representation. A content decoder of the multimodal generative model then takes the transformed latent representation as input and generates an output digital content item. If the input digital content item included multiple modalities, the output digital content item can be generated using multiple content decoders to provide content in the same modalities.

A performance metric decoder of the multimodal generative model 114 can also take the transformed latent representation as input and generate a predicted performance metric (or multiple performance metrics) for the output digital content item. The predicted performance metric and output digital content item can be provided to the administrative user to allow the user to understand how the digital content item is predicted to perform.

In some cases, multiple latent space transformations (e.g., different perturbations) are applied to the latent representation of the input digital content item to provide multiple transformed latent representations, and an output digital content item (and predicted performance metric, in some aspects) is generated for each transformed latent representation. This allows for multiple variant digital content items to be generated, and in some cases, predicted performance metric(s) to be provided for each variant. As such, a user can provide an input digital content item, and the multimodal generative model 114 provides one or more output digital content items with an indication of one or more performance metrics for each.

In other instances, in addition to a digital content item, the input can include a performance metric (or multiple performance metrics), contextual data, and/or a prompt (as well as additional inputs in the event the multimodal generative model 114 includes encoders for other types of input). In such aspects, the additional inputs are used to constrain or guide the latent space transformation by causing the latent space transformation to limit changes to features of the combined latent representation corresponding to the latent representation(s) of the constraining input(s).

As an example to illustrate, a target performance metric can be provided as input with a digital content item. For example, an administrative user could provide an input digital content item and a target performance metric (or multiple target performance metrics) in order to have the multimodal generative model provide one or more variants of the input digital content item that are predicted to meet the target performance metric(s). Given an input comprising a digital content item and predicted performance metric, a combined latent representation is generated by merging a latent representation of the target performance metric and a latent representation of the digital content item. When a latent space transformation is applied to the combined latent representation to provide a transformed latent representation, the latent space transformation limits adjustments to features of the combined latent representation corresponding to the latent representation of the target performance metric. As such, when an output digital content item is generated from the transformed latent representation, the output digital content item has a predicted performance metric that is the same as or similar to the target performance metric.

Similar approaches can be employed to constrain or guide the latent space transformation when the input includes contextual data, a prompt, or other constraining inputs. In Moreover, any combination of different constraining inputs can be used in conjunction with an input digital content item. A latent representation of each constraining input is generated by a corresponding encoder and merged with the latent representation of the digital content item to provide a combined latent representation. A latent space transformation to the combined latent representation is then constrained or guided by the latent representations of each constraining input, and an output digital content item is generated by a content decoder such that the output digital content item reflects features of the constraining inputs.

For instance, suppose an input is received that includes: an input digital content item that includes an image of a car in a city setting; a target performance metric (e.g., a target conversion rate); target contextual data (e.g., data specifying attributes of a target recipient group, such as: males, aged 40-60); and a text prompt that instructs generation of variants in which the car is shown in different settings. In that instance, latent representations of the various inputs are generated and merged to provide a combined latent representation. Multiple latent space transformations are performed, where each latent space transformation is constrained or guided by the latent representations of the target performance metric, contextual data, and prompt. In particular, each latent space transformation attempts to maintain features of the combined latent representation associated with the car in the image, the target performance metric, and the contextual data, while changing features that correspond to the setting in which the car is shown. For instance, an output digital content item could be generated in which the car is shown on a country road and another variant in which the car is shown on a mountain road. Additionally, based on the constraining inputs, the predicted performance metrics and contextual data of the output digital content items are the same as or similar to the target performance metric and target context data (e.g., the output digital content items are predicted to provide the target conversion rate when provided to males, aged 40-60).

Another use of the multimodal generative model 114 involves generating an output digital content item given an input comprising a prompt without any input digital content item. In some use cases, a prompt encoder generates a latent representation of the prompt, and a content decoder uses the latent representation to generate an output digital content item (or multiple latent representations can be encoded from the prompt in order to output multiple variants). In some aspects, multiple content decoders are employed to generate multiple modalities from the latent presentation of the prompt to provide an output digital content item comprised of the different modalities. In some cases, a performance metric decoder also takes the latent representation of the prompt as input and generates a predicted performance metric (or multiple performance metrics) for the output digital content item. This allows an administrative user to simply enter a text prompt to obtain one or more output digital content items from the multimodal generative model 114 with an indication of how each output digital content item is predicted to perform.

In addition to a prompt, the input can include additional data, such as a performance metric (or multiple performance metrics) and/or contextual data, (as well as additional inputs in the event the multimodal generative model 114 includes encoders for other types of input). If additional inputs are provided, a latent representation of each is generated using a corresponding encoder and merged with the latent representation of the prompt to provide a combined latent representation in the joint latent space of the multimodal generative model 114. The combined latent representation can then be decoded by a content decoder to provide an output digital content item.

In still further aspects, instead of generating digital content items, the multimodal generative model 114 can be used to determine predicted performance metric (or multiple predicted performance metrics) for a given digital content item. In particular, a digital content item is provided as input, and a content encoder generates a latent representation of the digital content item. A performance metric decoder takes the latent representation of the digital content item and generates a predicted performance metric (or multiple performance metrics) for the digital content item. This allows a user to assess how the digital content item will perform.

This performance metric prediction task can also involve additional inputs, such as contextual data. For instance, suppose a user would like to know how a particular content item is expected to perform with a certain target audience. The input includes the digital content item and contextual data for the target audience. A combined latent representation is generated from the digital content item and the contextual data, and a performance metric decoder takes the combined latent representation as input to provide a predicted performance metric that reflects how the digital content item is expected to perform for that target audience.

The content generation system also includes a user interface component 120 that provides one or more user interfaces for administrative users to interact with the content generation system 106. For instance, the user interface component 120 provides one or more user interfaces to admin devices, such as the admin device 104. In some instances, the user interfaces can be presented on the admin device 102 via the application 108, which can be a web browser or a dedicated application for interacting with the content generation system 106. Among other things, the user interface component 120 can provide user interfaces for interacting with the content generation system 106 to facilitate training the multimodal generative model 114, such as selecting training data and setting hyperparameters. In other instances, the user interface component 120 provides user interfaces for model inference, allowing administrative users to provide inputs (e.g., digital content items, target performance metrics, target contextual data, prompts, and/or other data) to the multimodal generative model 114 and providing output from the multimodal generative model 114 (e.g., generated digital content items, predicted performance metrics, and/or contextual data).

The content generation system 106 further includes a content delivery component 122. The content delivery component 122 communicates digital content items generated by the content generation system 106 over the network 108 to end user devices, such as the end user device 102. Each digital content item is communicated using appropriate an communication channel based on its content type (e.g., email, banner advertisement, social media post, etc.).

### Example Methods for a Multimodal Generative Model for Content Exploration

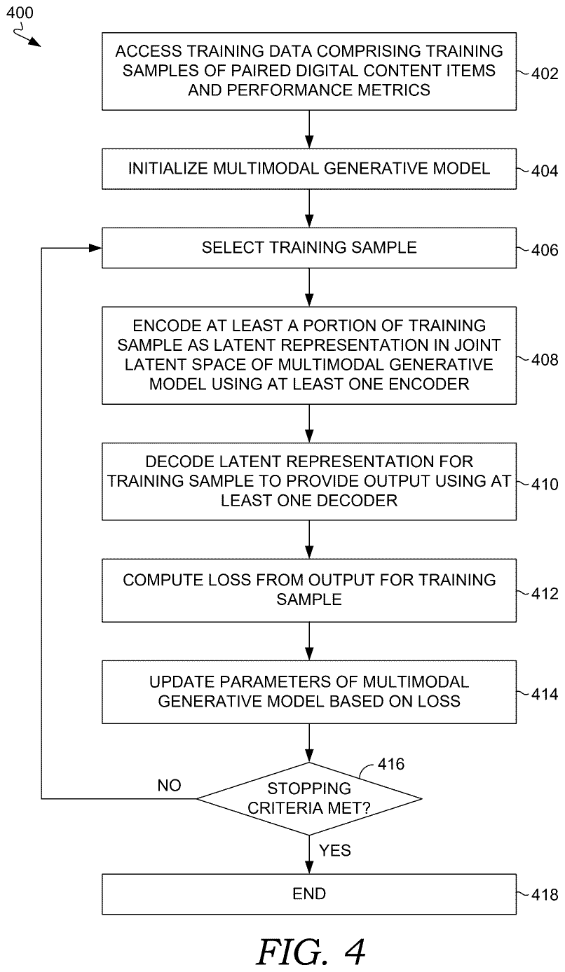

With reference now to FIG. 4, a flow diagram is provided that illustrates a method 400 for training a multimodal generative model. The method 400 can be performed, for instance, at least in part by the model training component 116 in order to train the multimodal model 112 of FIG. 1. Each block of the method 400 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, training data is accessed. The training data comprises training samples of paired digital content items and performance metrics. In particular, each training sample includes a digital content item that has been provided to recipients paired with one or more performance metrics regarding how the digital content item has performed. For instance, a variety of tracking mechanisms could be employed to capture the performance metrics for digital content items, such as, for instance: cookies, tracking pixels, URL tracking, browser fingerprinting, IP address tracking, device fingerprinting, impression tracking, conversion tracking, and ad tags. In some aspects, training samples can include additional information. For instance, a training sample could include a digital content item, performance metric(s), and contextual data. This reflects how the digital content item performed with recipients matching the contextual data. As such, multiple training samples can be provided for a given digital content item with different performance metrics for different contextual data.

The multimodal generative model is initialized, as shown at block 404. This can include setting up the model's architecture, such as selecting encoders and decoders designed to handle different modalities of digital content. The initialization process can also include setting initial values for model parameters (e.g., weights), which will be updated during training. The initialization process can further include selecting loss function(s) for training the multimodal generative model. Additional hyperparameters for training the model can also be specified, such as, for instance, regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

A training sample is selected from the training data, as shown at block 406. This sample includes a digital content item and its associated performance metric. As noted above, in some aspects, the training sample can also include contextual data. The selection process may be random or follow a specific sequence, depending on the training strategy employed. Additionally, when batch training is employed, a subset of training samples is selected at block 406, and the following blocks process each training sample from the batch.

As shown at block 408, at least a portion of the training sample is encoded as a latent representation in the joint latent space of the multimodal generative model using at least one encoder of the multimodal generative model. In some instances, both the digital content item and performance metric are encoded, and their latent representations are merged to provide a combined latent representation. When the digital content item includes multiple modalities, this may include employing a content encoder for each modality. In some aspects when the training sample includes contextual data, a latent representation of the contextual data is generated and merged to provide the combined latent representation. In further aspects, only a portion of the training sample is used to generate the latent representation. For instance, just the digital content item could be used to generate the latent representation at block 408. This supports employing a cross-modal loss during training. For instance, the latent representation of the digital content item can be decoded to provide a predicted performance metric, and a loss computed based on the predicted performance metric and the performance metric from the training sample.

At shown at block 410, the latent representation for the training sample is decoded to provide an output using at least one decoder of the multimodal generative model. This could include decoding the latent representation into, for instance, an output digital content item, predicted performance metric, output contextual data, and/or other data depending on the data included in the training sample, and the type of loss being determined (e.g., reconstruction loss, cross-modal loss, etc.). In the case of an input digital content item comprising multiple modalities, different content decoders can be used to decode the latent representation to provide each of the modalities in the output digital content item.

A loss is computed from the output for the training sample, as shown at block 412. This involves comparing the output digital content item, predicted performance metric, output contextual data, and/or other decoded data with data from the training sample depending on the data included in the training sample, and the type of loss being determined (e.g., reconstruction loss, cross-modal loss, etc.). For instance, a training sample could include a digital content item and performance metric, and the decoders generate an output digital content item and predicted performance metric. A reconstruction loss could then be determined for the digital content item (based on a comparison of the output digital content item to the digital content item from the training sample), and a reconstruction loss (which could be a regression loss) could be determined for the performance metric (based on a comparison of the predicted performance metric to the performance metric from the training sample). In some instances, a cross-modal loss is determined. For instance, given a training sample including a digital content item and corresponding performance metric, the latent representation generated at block 408 could be based on just the digital content item without the performance metric, and a predicted performance metric could be generated at block 410. The cross-modal loss would then be based on a comparison of the predicted performance metric with the performance metric from the training sample.

As shown at block 414, parameters (e.g., weights) of the multimodal generative model are updated based on the loss, for instance, via backpropagation. This can include adjusting the model parameters to minimize the loss, thereby improving the model performance. The update process can use optimization algorithms such as gradient descent.

As shown at block 416, a determination is made as to whether a stopping criterion is met. The stopping criterion can be usable to reduce overfitting of the multimodal generative model, reduce computational resource consumption, and/or promote an ability of the multimodal generative model to address previously unseen data (i.e., that is not included specifically as an example in the training data). Examples of a stopping criterion include, but are not limited to, a predefined number of epochs, validation loss stabilization, achievement of a performance improvement threshold, whether a threshold level of accuracy has been met, or based on performance metrics such as precision and recall. If the stopping criterion has not been met, the method 400 continues training of the multimodal generative model using a new training sample (or batch of training samples), as shown by the return to block 406. If the stopping criterion is met at block 416, the process ends at block 418, for instance by freezing parameters of the multimodal generative model. The result is a trained multimodal generative model, which can then be used to generate an output for one or more inference tasks.

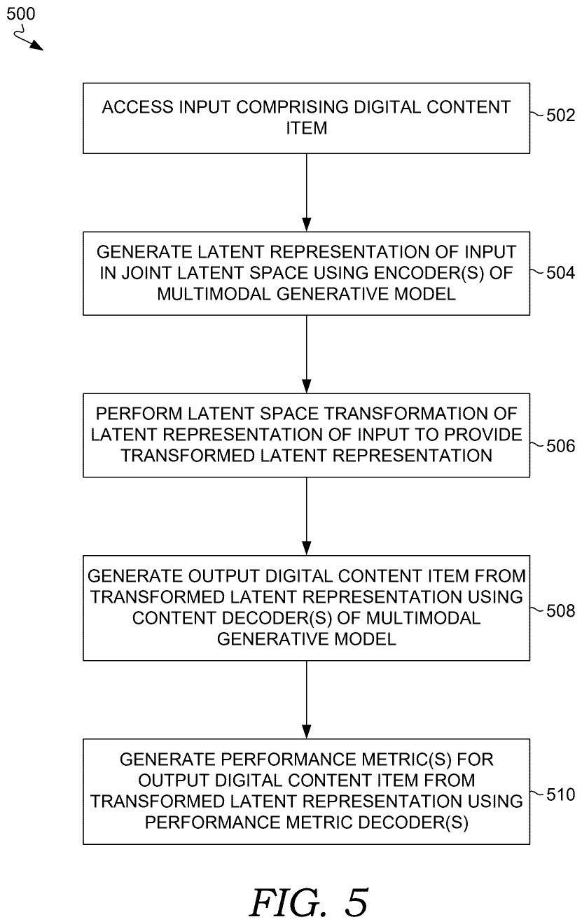

FIGS. 5-9 provide examples of different inference tasks that can performed using a trained multimodal generative model (e.g., trained using the method 400 of FIG. 4). It should be understood that these are only provided by way of example only, and other inference tasks can be performed depending on the architecture of the multimodal generative model. With initial reference to FIG. 5, a flow diagram is provided showing a method 500 for employing a multimodal generative model as described herein to generate, from an input comprising a digital content item, an output digital content item and a predicted performance metric for the output digital content item. The method 500 could be performed, for instance, by the model inference component 114 using the multimodal model 112 of FIG. 1.

As shown at block 502, input comprising a digital content item is accessed. For instance, a digital content item could be provided to the content generation system by an administrative user in order to generate output digital content item(s) for content exploration purposes. The digital content item can include a single modality or multiple modalities. The modalities can include, for instance, text, image(s), audio, and/or video.

As shown at block 504, one or more encoders of the multimodal generative model generate a latent representation of the input in a joint latent space of the multimodal generative model. This joint latent space was learned from training the multimodal generative model on training data comprising training samples of digital content items paired with performance metrics (e.g., using the method 400 of FIG. 4). In some configurations, the training data can include further data. For instance, training samples can include contextual data with the digital content items and corresponding performance metrics.

The one or more encoders employed by the multimodal generative model include a content encoder that generates a latent representation of the digital content item. For digital content items with multiple modalities, the content encoder comprises an encoder for each modality in order to generate a latent representation for each modality. For instance, a digital content item could include both text and an image. In that case, a text encoder would be used to generate a latent representation of the text, and an image encoder would be used to generate a latent representation of the image. In some aspects, the latent representations of the different modalities are merged to provide a latent representation of the digital content item.

In some aspects, the multimodal generative model employs additional encoders based on the input. For instance, if the input includes a target performance metric, a performance metric encoder generates a latent representation of the target performance metric, which is merged with the latent representation of the digital content item in order to provide the latent representation of the input. If the input includes target contextual data, a contextual data encoder generates a latent representation of the target contextual data, which is merged with the latent representation of the digital content item to provide the latent representation of the item. If the input includes a prompt, a prompt encoder generates a latent representation of the prompt, which is merged with the latent representation of the digital content item to generated the latent representation of the input. Any combination of the different inputs and corresponding encoders could be employed.

As shown at block 506, a latent space transformation from the latent representation of the input is performed in the joint latent space of the multimodal generative model to provide a transformed latent representation. In some aspects, the latent space transformation can be constrained in one or more ways. For instance, in the case in which the input includes a target performance metric, the latent space transformation can be constrained by the latent representation of the target performance metric. In the case in which the input includes target contextual data, the latent space transformation can be constrained by the latent representation of the target contextual data. In the case in which the input includes a prompt, the latent space transformation can be constrained by the latent representation of the prompt.

One or more content decoders of the multimodal generative model generate an output digital content item from the transformed latent representation, as shown at block 508. In some cases, the output digital content item comprises multiple modalities. In such instances, a content decoder for each modality is used in order to generate digital content in each modality. For instance, an output digital content item could be generated to include both text and an image. In that case, a text decoder would be used to generate text from the transformed latent representation, an image decoder would be used to generate an image from the transformed latent representation, and the output digital content item is generated by combining the outputs for each modality. In some configurations, multiple latent space transformations are performed at block 506 to provide multiple transformed latent representations, which are each decoded to provided multiple output digital content items at block 508.

As shown at block 510, one or more performance metric decoders generate one or more predicted performance metrics for the output digital content item from the transformed latent representation. This provides an indication of how the output digital content is predicted to perform. When multiple output digital content items are generated, one or more predicted performance metrics are generated for each output digital content item by decoding the corresponding transformation latent representation for each digital content item.

Although not shown in FIG. 5, in some further aspects, a contextual data decoder can also generate contextual data for the output digital content item from the transformed latent representation. As such, the multimodal generative model can be used to provide the predicted performance metric of the output digital content item within the context of the output contextual data. For instance, the output contextual data can comprise data defining recipient demographics, and the output from the multimodal generative model comprises an indication of the predicted performance metric for proving the output digital content item to recipients with those demographics.

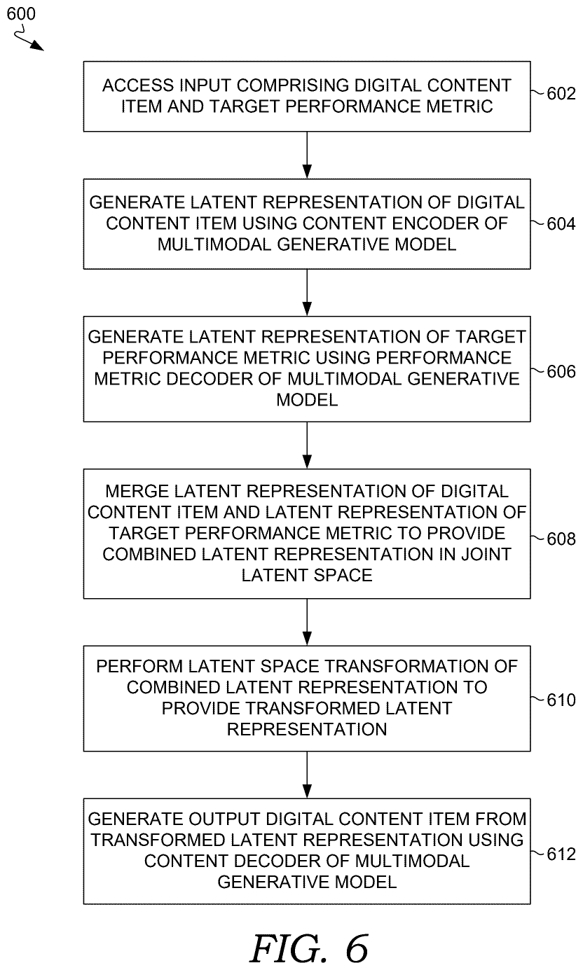

With reference next to FIG. 6, a flow diagram is provided showing a method 600 for employing a multimodal generative model as described herein to generate, from an input comprising a digital content item and a target performance metric, an output digital content item that is predicted to satisfy the target performance metric. The method 600 could be performed, for instance, by the model inference component 114 using the multimodal model 112 of FIG. 1.

As shown at block 602, an input comprising a digital content item and a target performance metric (or multiple target performance metrics) is accessed. As shown at block 604, a latent representation of the digital content item is generated by a content encoder of the multimodal generative model. If the digital content item comprises multiple modalities, the content encoder comprises an encoder for each modality, and a latent representation is generated for each modality. As shown at block 606, a latent representation of the target performance metric is generated by a performance metric encoder of the multimodal generative model. In cases in which the input received at block 602 also includes target contextual data, a latent representation of the target contextual data is generated by a contextual data encoder of the multimodal generative model. In cases in which the input received at block 602 also includes a prompt, a latent representation of the prompt is generated by a prompt encoder of the multimodal generative model.

As shown at block 608, the latent representation of the digital content item is merged with the latent representation of the target performance metric by a merging component of the multimodal generative model to provide a combined latent representation in the joint latent space of the multimodal generative model. In cases in which the input received at block 602 also includes target contextual data, the latent representation of the target contextual data is also merged to provide the combined latent representation. In cases in which the input received at block also 602 includes a prompt, the latent representation of the prompt is also merged to provide the combined latent representation.

As shown at block 610, a latent space transformation from the combined latent representation is performed in the joint latent space of the multimodal model to provide a transformed latent representation. The latent space transformation is constrained by the latent representation of the target performance metric. In cases in which the input received at block 602 also includes target contextual data, the latent space transformation is also constrained by the latent representation of the target contextual data. In cases in which the input received at block 602 also include a prompt, the latent space transformation is also constrained by the latent representation of the prompt.

As shown at block 612, an output digital content item is generated from the transformed latent representation by a content decoder of the multimodal generative model. If the output digital content item comprises multiple modalities, the content decoder comprises a decoder for each modality to generate an output for each modality, and the output digital content item is generated by combining the outputs for each modality. In some instances, multiple transformed latent representations are provided at block 610, and each transformed latent representation is decoded to provide multiple output digital content items at block 612.

Although not shown in FIG. 6, in some aspects, a performance metric for the output digital content item is generated from the transformed latent representation by a performance metric decoder (e.g., as a way to verify the predicted performance metric for the output digital content item satisfies the target performance metric). Additionally, although not shown in FIG. 6, in some aspects, contextual data for the output digital content item is generated from the transformed latent representation by a contextual data decoder.

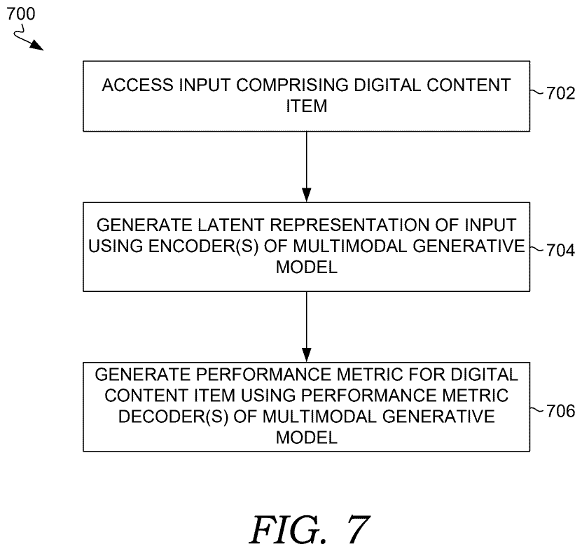

FIG. 7 provides a flow diagram showing a method 700 for employing a multimodal model as described herein to generate, from an input comprising a digital content item, a predicted target performance metric for the input digital content item. This allows an administrative user to provide a digital content item and receive predicted performance metric(s) to view how that digital content item is predicted to perform. The method 700 could be performed, for instance, by the model inference component 114 using the multimodal model 112 of FIG. 1.

As shown at block 702, an input comprising a digital content item is accessed. In the method 700, no target performance metric is provided. As shown at block 704, a latent representation of the input in the joint latent space of the multimodal generative model is generated by one or more encoders of the multimodal generative model. This joint latent space was generated by training the multimodal generative model on training data comprising pairs of digital content items with performance metrics. In some configurations, the training data can include further data. For instance, contextual data could be provided as training data with a given pair of a digital content item and its corresponding performance metric(s).

The one or more encoders include a content encoder that generates a latent representation of the digital content item. If the digital content item comprises multiple modalities, the content encoder comprises an encoder for each modality, generating a latent representation for each modality, and the latent representation of the digital content item comprises the latent representation for each modality. In instances in which the input received at block 702 also includes target contextual data, a contextual data encoder of the multimodal generative model generates a latent representation of the target contextual data, and the latent representation of the input is generated by merging the latent representation of the digital content item with the latent representation of the target contextual data. For instance, an administrative user could provide target contextual data as input with the digital content item in order to have the multimodal generative model generate a predicted performance metric indicative of how that digital content item is predicted to perform for a target audience matching the target contextual data.

As shown at block 706, a predicted performance metric for the digital content item is generated by a performance metric decoder of the multimodal generative model based on the latent representation of the input generated at block 704. In some aspects, multiple predicted performance metrics are generated for the digital content item at block 706. Although not shown in FIG. 7, in some instances, contextual data is also generated by a contextual data decoder of the multimodal generative model based on the latent representation of the input.

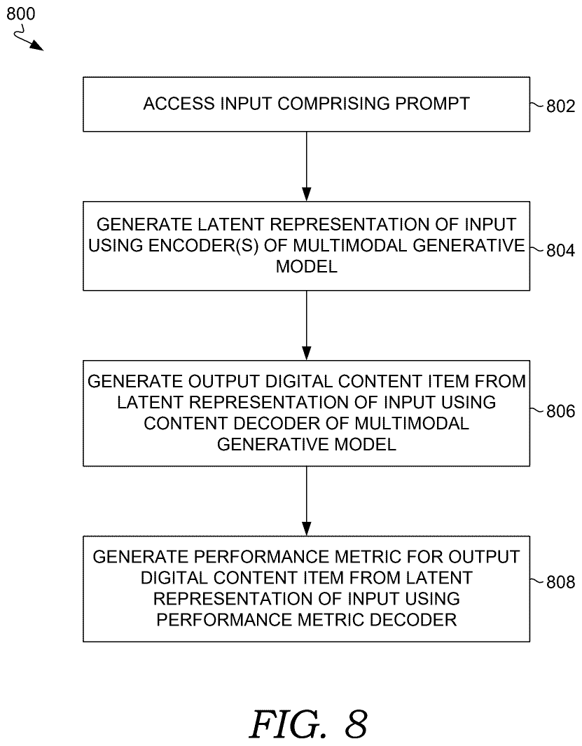

Turning next to FIG. 8, a flow diagram is provided showing a method 800 for generating an output digital content item and a predicted performance metric for the output digital content using a multimodal generative model when the input comprises a prompt without a digital content item or target performance metric. The method 800 could be performed, for instance, by the model inference component 114 using the multimodal model 112 of FIG. 1.

As shown at block 802, an input comprising a prompt is accessed. The prompt can comprise natural language text such as, for instance, text describing a desired image for a digital content item. In some aspects when the output digital content item is intended for a certain target audience, the input can include target contextual data.

As shown at block 804, a latent representation of the input is generated using at least one encoder of the multimodal generative model. In particular, a prompt encoder is used to generate a latent representation of the prompt. In instances in which the input also includes contextual data, a contextual data encoder is also used to generated a latent representation of the contextual data, which is merged with the latent representation of the prompt.

An output digital content item is generated from the latent representation of the input using a content decoder of the multimodal generative model, as shown at block 806. In some instances, multiple content decoders for different modalities are used to provide an output digital content item comprising different modalities. Additionally, in some instances, multiple digital content items are generated at block 806, for instance by introducing perturbations to the latent representation generated at block 804 to provide multiple latent representations for decoding.

As shown at block 808, a predicted performance metric (or multiple performance metrics) for the output digital content item is generated from the latent representation using a performance metric decoder. When multiple output digital content items are generated, predicted performance metric(s) are decoded for each.

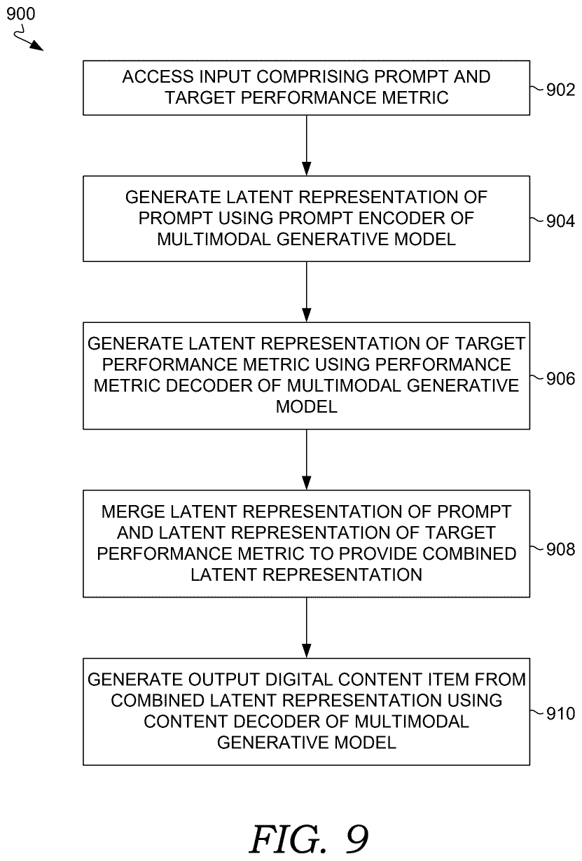

FIG. 9 is a flow diagram showing a method 900 for generating an output digital content item using a multimodal generative model given a prompt and a target performance metric. The method 900 could be performed, for instance, by the model inference component 114 using the multimodal model 112 of FIG. 1.

As shown at block 902, input comprising prompt and a target performance metric (or multiple target performance metrics) is received without a digital content item. In some aspects when digital content for a certain target audience is desired, the input can also include target contextual data.

A latent representation of the prompt is generated using a prompt encoder of the multimodal generative model, as shown at block 904. Additionally, a latent representation of the target performance metric is generated using a performance metric encoder of the multimodal generative model, as shown at block 906. The latent representation of the prompt and the latent representation of the target performance metric are merged to provide a combined latent representation in the joint latent space of the multimodal generative model, as shown at block 908. Although not shown in FIG. 9, in instances in which the input also includes target contextual data, a latent representation of the target contextual data is also generated and merged to provide the combined latent representation.

As shown at block 910, an output digital content item is generated from the combined latent representation using a content decoder of multimodal generative model. In some instances, multiple content decoders for different modalities are used to provide an output digital content item comprising different modalities. Additionally, in some instances, multiple digital content items are generated at block 910, for instance by introducing perturbations to the combined latent representation generated at block 908 to provide multiple latent representations for decoding.

### Exemplary Operating Environment

Having described implementations of the present disclosure, an exemplary operating environment in which embodiments of the present technology may be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 may be equipped with depth cameras, such as, stereoscopic camera systems, infrared camera systems, RGB camera systems, and combinations of these for gesture detection and recognition. Additionally, the computing device 1000 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing input comprising a digital content item;
causing one or more encoders of a multimodal generative model to generate a latent representation of the input in a joint latent space of the multimodal generative model learned from training data comprising pairs of digital content items with performance metrics, wherein the one or more encoders comprise a content encoder that generates a latent representation of the digital content item;
causing a latent space transformation from the latent representation of the input to a transformed latent representation;
causing a content decoder of the multimodal generative model to generate an output digital content item from the transformed latent representation; and
causing a performance metric decoder of the multimodal generative model to generate a performance metric for the output digital content item from the transformed latent representation.

2. The one or more computer storage media of claim 1, wherein the digital content item comprises two or more modalities;
wherein the content encoder comprises an encoder for each modality of the two or more modalities that generates a latent representation for each modality of the two or more modalities; and
wherein the latent representation of the digital content item comprises the latent representation for each modality.

3. The one or more computer storage media of claim 1, wherein the input further comprises a target performance metric;
wherein the one or more encoders comprise a performance metric encoder that generates a latent representation of the target performance metric;
wherein the latent representation of the input is generated by merging the latent representation of the digital content item with the latent representation of the target performance metric; and
wherein the latent space transformation is constrained by the latent representation of the target performance metric.

4. The one or more computer storage media of claim 1, wherein the input further comprises target contextual data;
wherein the one or more encoders comprise a contextual data encoder that generates a latent representation of the target contextual data;
wherein the latent representation of the input is generated by merging the latent representation of the digital content item with the latent representation of the target contextual data; and
wherein the latent space transformation is constrained by the latent representation of the target contextual data.

5. The one or more computer storage media of claim 1, wherein the input further comprises a prompt;
wherein the one or more encoders comprise a prompt encoder that generates a latent representation of the prompt;
wherein the latent representation of the input is generated by merging the latent representation of the digital content item with the latent representation of the prompt; and
wherein the latent space transformation is constrained by the latent representation of the prompt.

6. The one or more computer storage media of claim 1, wherein the output digital content item comprises two or more modalities;
wherein the content decoder comprises a decoder for each modality of the two or more modalities to generate an output for each modality of the two or more modalities; and
wherein the output digital content item is generated by combining the output for each modality of the two or more modalities.

7. The one or more computer storage media of claim 1, wherein the operations further comprise:
causing a contextual data decoder to generate contextual data for the output digital content item from the transformed latent representation.

8. The one or more computer storage media of claim 1, wherein a plurality of latent space transformations from the latent representation of the input are caused to provide a plurality of transformed latent representations; and wherein a plurality of output digital content items are generated from the plurality of transformed latent representations.

9. A computer-implemented method comprising:
generating, by a content encoder of a multimodal generative model, a latent representation of a digital content item;
generating, by a performance metric encoder of the multimodal generative model, a latent representation of a target performance metric;
merging, by a merging component of the multimodal generative model, the latent representation of the digital content item with the latent representation of the target performance metric to provide a combined latent representation in a joint latent space of the multimodal generative model;
performing a latent space transformation from the combined latent representation to a transformed latent representation, wherein the latent space transformation is constrained by the latent representation of the target performance metric; and
generating, by a content decoder of the multimodal generative model, an output digital content item from the transformed latent representation.

10. The computer-implemented method of claim 9, wherein the digital content item comprises two or more modalities;
wherein the content encoder comprises an encoder for each modality of the two or more; and
wherein generating the latent representation of the digital content item comprises generating a latent representation for each modality of the two or more modalities.

11. The computer-implemented method of claim 9, wherein the operations further comprise:
generating, by a contextual data encoder, a latent representation of target contextual data; and
wherein the latent representation of the target contextual data is merged with the latent representation of the digital content item and the latent representation of the target performance metric to provide the combined latent representation; and
wherein the latent space transformation is also constrained by the latent representation of the target contextual data.

12. The computer-implemented method of claim 9, wherein the input further comprises a prompt;
wherein the operations further comprise generating, by a prompt encoder, a latent representation of the prompt;
wherein the latent representation of the prompt is merged with the latent representation of the digital content item and the latent representation of the target performance metric to provide the combined latent representation; and
wherein the latent space transformation is also constrained by the latent representation of the prompt.

13. The computer-implemented method of claim 9, wherein the operations further comprise:
causing a performance metric decoder to generate a performance metric for the output digital content item from the transformed latent representation.

14. The computer-implemented method of claim 9, wherein the output digital content item comprises two or more modalities;
wherein the content decoder comprises a decoder for each modality of the two or more modalities to generate an output for each modality of the two or more modalities; and
wherein the output digital content item is generated by combining the output for each modality of the two or more modalities.

15. The computer-implemented method of claim 9, wherein the operations further comprise:
causing a contextual data decoder of the multimodal generative model to generate contextual data for the output digital content item from the transformed latent representation.

16. The computer-implemented method of claim 9, wherein a plurality of latent space transformations from the combined latent representation are performed to provide a plurality of transformed latent representations; and wherein a plurality of output digital content items are generated from the plurality of transformed latent representations.

17. A computer system comprising:
one or more processors; and
one or more computer storage media storing computer-useable instructions that, when used by the one or more processors, causes the computer system to perform operations comprising:
generating, by one or more encoders of a multimodal generative model, a latent representation of input in a joint latent space of the multimodal generative model learned from training data comprising pairs of digital content items with performance metrics, wherein the input comprises a digital content item, and wherein the one or more encoders comprise a content encoder that generates a latent representation of the digital content item; and
generating, by a performance metric decoder of the multimodal generative model, a performance metric for the digital content item based on the latent representation of the input.

18. The computer system of claim 17, wherein the digital content item comprises two or more modalities;
wherein the content encoder comprises an encoder for each modality of the two or more modalities that generates a latent representation for each modality of the two or more modalities; and
wherein the latent representation of the digital content item comprises the latent representation for each modality.

19. The computer system of claim 17, wherein the input further comprises target contextual data;
wherein the one or more encoders comprise a contextual data encoder that generates a latent representation of the target contextual data; and
wherein the latent representation of the input is generated by merging the latent representation of the digital content item with the latent representation of the target contextual data.

20. The computer system of claim 17, wherein the operations further comprise:
causing a contextual data decoder of the multimodal generative model to generate contextual data from the latent representation of the input.
